(19) United States
(12) Patent Application Publication
(10) Pub. No.: US 2012/0145480 A1
(43) Pub. Date: Jun. 14, 2012

(54) Ladder Deployment System

(76) Inventors: Brett Willis, Rutherford (AU); Sreenath Bhaskaran Leela, Rutherford (AU); Henry Grodzki, Rutherford (AU)

(21) Appl. No.: 13/201,642

(22) PCT Filed: Dec. 23, 2009
(86) PCT No.: PCT/AU2009/001702

§ 371 Date: Feb. 21, 2012

(30) Foreign Application Priority Data
Feb. 16, 2009 (AU) 2009900647

(51) Int. Cl. E06C 5/04; E06C 7/18

(52) U.S. Cl. 182/106; 182/127

(57) ABSTRACT

A ladder deployment system for raising and lowering a ladder (10) includes a ladder having side rails (14, 16) and transverse treads or rungs (18) extending between said side rails, an actuator mechanism (44, 46) which moves the ladder between a raised and lowered positions and stationary guides (34, 36) which supports the ladder at two or more spaced apart locations at different heights, while said ladder translates relative to the guides. The deployment of the ladder between its raised and lowered positions includes a generally vertical translation of the ladder and a further tilting motion.

### FIELD OF THE INVENTION

The present invention relates to ladder deployment arrangements such as those used on earth moving vehicles and mining equipment so as to raise and lower a ladder allowing people to gain access to the vehicle.

### BACKGROUND OF THE INVENTION

Prior art ladder deployment systems, such as those depicted in Australian Patents 738307 and 200300356 utilise rotating ladders or at least part of the ladder rotating at the point of connection to a vehicle. Such rotation, due to the arcuate path away from the vehicle, requires a relatively large clearance envelope in the vicinity of the deployment system for the operator to operate the system, and ladders of this type are frequently damaged in use.

Another prior art system utilised a guide wheel and track. However such systems have resulted in ladders at some point during their deployment, encroaching upon or occupying platform space which may be occupied by a vehicle operator or other person on the platform. Such encroachment is dangerous to the operator or person in that location.

Any reference herein to known prior art does not, unless the contrary indication appears, constitute an admission that such prior art is commonly known by those skilled in the art to which the invention relates, at the priority date of this application.

### SUMMARY OF THE INVENTION

In one form, the present invention provides a ladder deployment system for raising and lowering a ladder between a raised position and a lowered, inclined position, the system including a ladder having side rails and transverse supports such as steps or rungs extending between the side rails, and deployment actuator means and guide means adapted to deploy the ladder in one stage comprising generally vertical translation of the ladder and another stage including tilting the ladder between generally vertical and inclined dispositions.

Optionally, the guide means engages the ladder at two or more points at different heights. Preferably, the guide means engages the ladder at two or more points generally vertically spaced apart positions.

Optionally the guide means constrains the inclination of a portion of the ladder which is engaged with the guide means at the time. Preferably, the ladder includes upper and lower ladder portions disposed at an angle relative to each other, and engagement of the ladder with the guide means in a transition portion between the upper and lower ladder portions results in the tilting stage of the deployment.

In a further form, the present invention provides a ladder deployment system for raising and lowering a ladder the system including a ladder having side rails and transverse supports such as steps or rungs extending between the side rails, a movement actuator means to move the ladder between a raised and lowered condition and a guide means held stationary, the guide means including means to support the ladder at two or more spaced apart locations, which are at different heights while the ladder translates relative to the guide means.

The movement actuator means can directly engage the ladder.

The movement actuator means can be associated with the guide means.

The movement actuator means can be independent of the guide means.

The movement actuator means can be a linear actuator, such as a hydraulic cylinder and piston connected between a stationary location and the ladder to deploy the ladder.

The side rails can include one or more tracks to engage the guide means.

The guide means can be located between tracks located on the side rails.

The guide means can be located either side of a track located on the side rails.

The track and the guide means can have respectively a rack and pinion construction.

The movement actuator means can be a means to drive the pin to move the track relative to the guide means.

The movement actuator means can include a winch and a chain or cable, which operates to lift the ladder to a raised condition with gravity being used in association with the winch to move the ladder to a lowered condition.

The ladder side rails can have at least two straight sections each section being at an angle to each other.

Both sections engage the guide means.

The system can have one section in a generally vertical condition when the ladder is in the lowered condition, while a second section can be in the vertical condition when the ladder is in the raised condition.

The movement of the ladder relative to the guide means results in the ladder rotating as it is deployed.

The guide means can be attached to a vehicle.

The movement actuator means can be attached to the vehicle.

The movement actuator means can be connected to a housing or mounting for the guide means.

The ladder can include a hand rail which translates and rotates with the ladder.

The ladder and or the hand rail does not move inboard of the most inboard location of the ladder deployment system in either lowered or raised condition or therebetween.

The system can be controlled to raise the ladder to the raised condition, in response to a vehicle's parking brake being released.

The movement actuator means and the ladder in combination is able to impart to the ladder first a translation motion to said ladder, as the ladder moves relative to the guide means, then a rotation motion, and finally a translation motion.

The movement actuator means provides the motion described in the previous paragraph when the ladder is being raised or lowered.

### BRIEF DESCRIPTION OF THE DRAWINGS

An embodiment or embodiments of the present invention will now be described, by way of example only, with reference to the accompanying drawings, in which:

FIG. 1 is a perspective view of a ladder deployment system;

FIG. 2 is an enlarged view of a portion of FIG. 1 showing a guide means and two rollers in additional detail;

FIG. 3 is a side view of the ladder deployment system showing a ladder in a lowered position superimposed over a ladder in a raised position;

FIG. 4 shows the ladder deployment system of FIG. 1 in the lowered condition;

FIG. 5 is a series of side views from (a) to (e) showing the lowering of a ladder deployment system as illustrated in FIG. 1 from left to right, or a raising from right to left;

FIG. 6 illustrates an schematic view of an alternative guide arrangement;

FIG. 7 illustrates a part perspective view of a flange or track having a rack formed as part thereof;

FIG. 8 is a perspective view of a flange or track having a series of apertures to allow engagement with a pinion so as to transmit motive force therebetween; and

FIGS. 9 to 11 are schematic front views of ladders and guide means showing the guide means arrangements that can be utilised in embodiments of this invention.

### DETAILED DESCRIPTION OF THE EMBODIMENT OR EMBODIMENTS

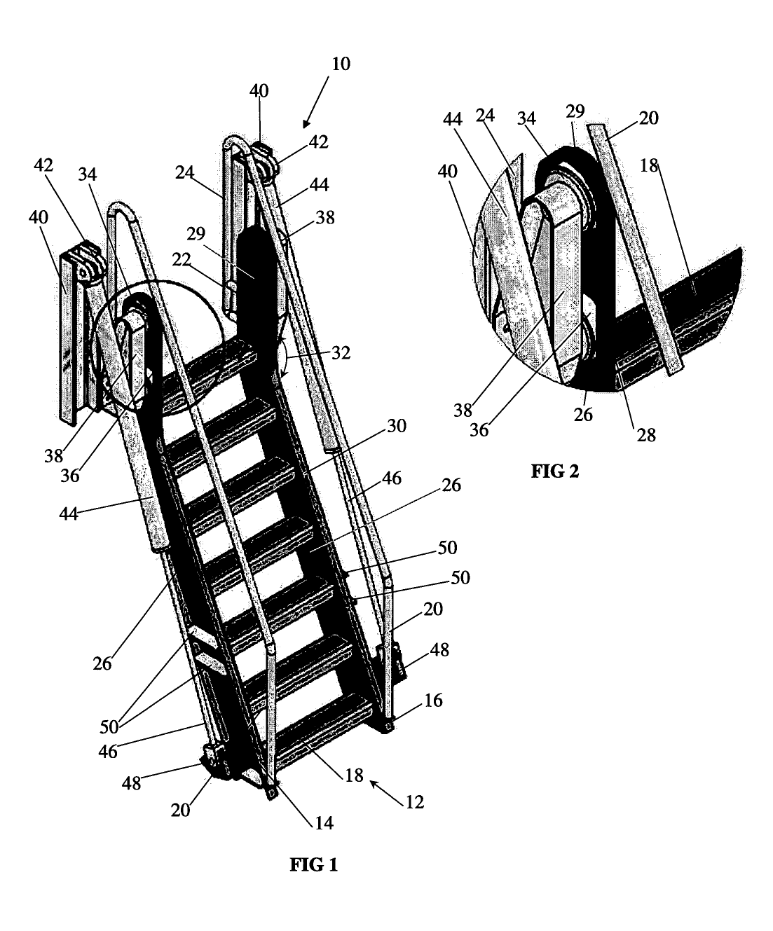

Illustrated in FIG. 1, is a ladder deployment system 10 which has a ladder 12 with a left side rail 14 and a right side rail 16 held in a spaced apart relationship by welded stair treads or rungs 18. A hand rail 20 is attached to the base of the side rails 14 and 16 and proceeds parallel to the angle of elevation of the stair treads 18 and is secured at 22 to a point below the upper end of the side rails 14 and 16.

In this embodiment of the ladder deployment system 10, the hand rail 20 proceeds to the inboard side of the end of the side rails 14 and 16 so that the vertical portion 24 on the inboard side of the hand rail 20 is located close to an adjacent hand rail (not illustrated) which is present on a typical vehicle (also not illustrated) to which the ladder deployment system 10 can be attached.

If desired, and depending upon the vehicle to which the deployment system might be attached, the hand rail 20 and the vertical portion can terminate at the upper ends 29 of the side rails 14 and 16.

The side rails 14 and 16 are made from a U-shaped or C-shaped sections so as to provide a side 26 to which can be attached the stair treads 18 and an edge flange 28 which runs entirely around the periphery of the side plates 26. As is illustrated in FIG. 1, the side rails 14 and 16 have an overall chevron or dog leg shape whereby the angle between the end 29 of the side rails 14 and 16 to that portion 30 of the side rails 14 and 16 (to which the stair treads 18 are secured) has an included angle 32 of between approximately 135 to 150 degrees.

When the ladder 12 is in the lowered position, the ends 29 of the side rails 14 and 16 are in a substantially vertical condition. When the ends 29 are in a vertical condition, the side rails 30 are at the appropriate angle so that the stair treads 18 provide a generally horizontal surface for an operator or user to walk on.

An advantage of the side rails 14 and 16 having a peripheral flange 28 around them is that the peripheral flanges 28 provide a track on two sides of the side rail in which can travel, in a relative sense, on polymeric rollers 34 and 36 which are preferably of the same outside diameter. The edge flange 28 at the terminus of the end 29 is rounded and limits the travel of the end 29 in the downward direction.

The centres of rotation of the rollers 34 and 36 are arranged so that when the deployment system 10 is mounted to a vehicle, the axis of rotation of the rollers 34 and 36 while being generally horizontal are aligned, one above the other, in a generally vertical arrangement. This ensures that the end 29 of the side rails 14 and 16 when the ladder is in a lowered condition, and the lower ends of the side rails 14 and 16, when the ladder is in a raised condition, will be in a generally vertical orientation.

The rollers 34 and 36 are preferably of a diameter which is less than the perpendicular distance between opposing faces of the peripheral flange 28. By being a lesser distance the rollers 34 and 36 will only engage the peripheral flange 28 on one side of each of the side rails 14 and 16 at a time.

The rollers 34 and 36 are idler rollers and are mounted for rotation to a guide body 38 which is generally of a construction to holds the rollers 34 and 36 apart. The guide body 38 is mounted to U-shaped channel mounts 40 which attach to a mounting plate welded to the vehicle. Any appropriate means can be used for such attachment including bolting or welding if desired. The mounts 40 include a yolk 42 to pivotally hold one end of a hydraulic cylinder 44. A cylinder 44 is located on either side of the deployment system 10. The pistons or rods 46 of the hydraulic cylinders 44 are pivotally mounted by mountings 48 to the side rails 14 and 16 respectively, which, in the case of FIG. 1, the pivotal mounting is at or near the extremity of the respective side rails 14 and 16. The location of the pivot attachment mountings 48 on the side rails 14 and 16 is dependent upon the length of the stair or ladder 12 being deployed and also a function of the extended and retracted lengths of the hydraulic cylinder 44 and associated piston 12.

A pair of horizontal plates 50 are provided on the side rails 14 and 16 so as to provide strength to the stair assembly 12.

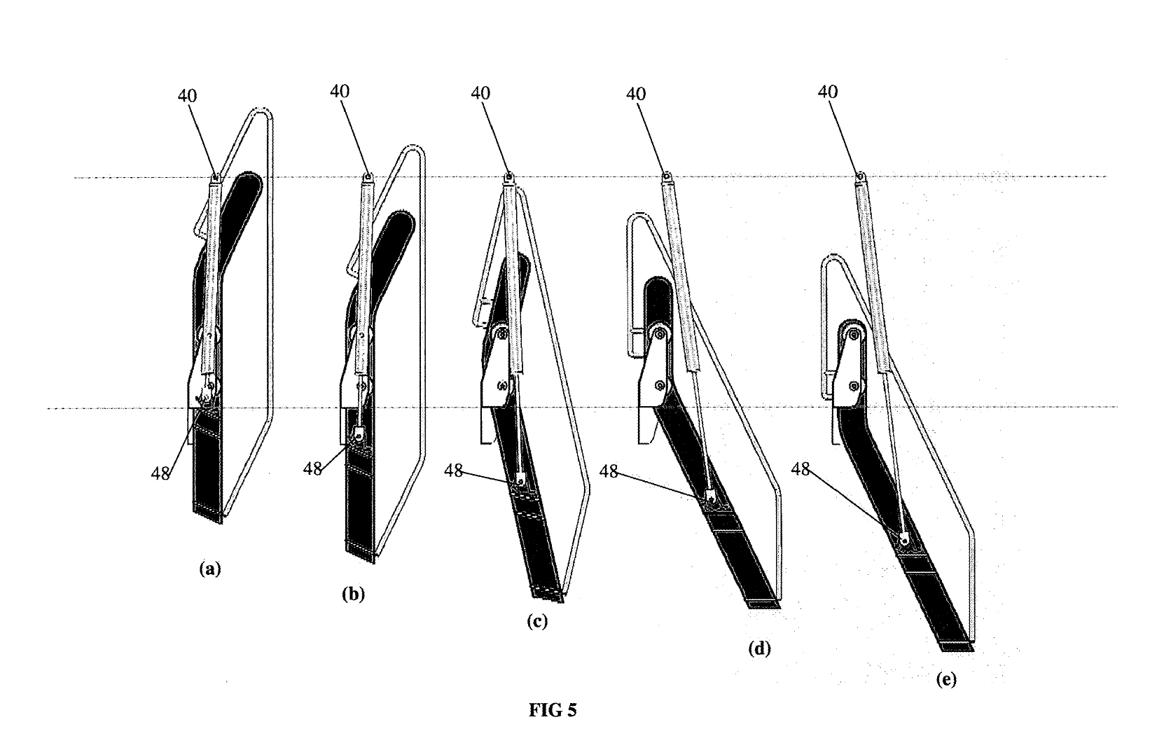

In operation, to raise the ladder of FIG. 1, the operator will cause the retraction of the piston 46 into the hydraulic cylinder 44, which in the sequential illustration of FIG. 5 is in the direction of FIG. 5(e) through FIG. 5(a) from right to left, causing a shortening of the lineal distance between the yolk 42 and the pivot mount 48.

Because the guide rollers on each side are vertically one above the other, the respective points of the track which are engaged with the rollers at any time are constrained also to be vertically one above the other. Thus, in the lowered position shown in FIG. 1, the upper end portion of the ladder is held vertical, and the lower portion is inclined. As the piston is retracted, the initial movement of the ladder is to rise by substantially vertical translation as the peripheral flanges in the upper end 29 of the side rails 14 & 16 are engaged by the rollers.

Continued retraction of the pistons 12 in the hydraulic cylinders 44 causes the side rails 14 and 16 to continue in a vertical direction as in FIG. 5C until the point where the dog leg transition in side rails reaches the rollers. At this point ladder is caused to rotate in a generally clockwise direction as the fixed position guide rollers track around the dog leg as the side rails 14 and 16 are lifted. The rollers 34 and 36 continue to track and guide the side rails 14 and 16 until the lower sections 30 of the side rails 14 and 16 are generally vertical, and are held so by the location and positioning of the rollers 34 and 36 as is illustrated in FIG. 5B. Continued retraction of the pistons 46 into the cylinders 44 causes the side rails 14 and 16 to be further lifted vertically until the side rails 14 and 16 are moved into the fully raised condition.

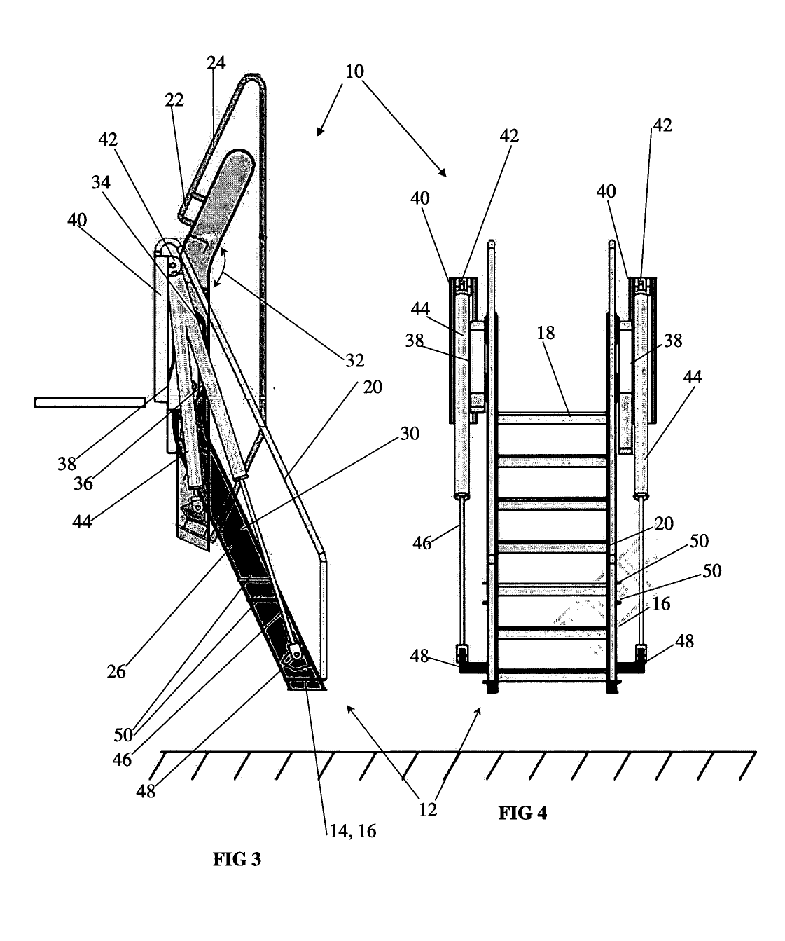

Illustrated in FIG. 3, is a superimposition of the ladder deployment system 10 in the fully raised position relative to the fully lowered position which shows that the ladder does not extend past the left hand or inboard side of the deployment system 10 in either the fully raised or fully lowered condition.

Illustrated in FIG. 5, the mounting channel 40 has been removed for illustration clarity purposes but it would be readily understood that if the mounting channel 40 were illustrated in its position that at no point in the travel from the fully raised to the fully lowered positions of FIGS. 5(a) to 5(e) right to left or left to right, does any portion of the side rails 14 and 16 or hand rails 40 protrude to the left hand or inboard side past the inboard periphery of the mounting channels 40.

As will be noted, the deployment system 10 of FIG. 5, has differences to the system illustrated in FIGS. 1 to 4 in that the pivot mounts 48 are located at a higher location on the side rails 14 and 16 whilst the location of the upper pivot of the hydraulic cylinder 44, being 44.1 are at a higher location than that illustrated in FIGS. 1 to 4. These differences however, are a function of ladder length, and hydraulic cylinder length and will be varied according to the geometry required to suit specific vehicles.

It will be noted from FIG. 4 and FIG. 5 that the right hand side guide body 38 is significantly greater in height than the guide body 38 on the left hand side. The reason for this is that the specific vehicle to which this embodiment is attached has chassis or superstructure components which dictate the size of the guide bodies 38 in the left or right sides.

In the above embodiment the guide bodies 38 each utilise two rollers 34 and 36 in a generally vertical arrangement. If desired a greater number of rollers could be utilised but this may require that the width of the sides 26 increases so as to ensure that the side rails 14 and 16 will track with respect to the rollers through the included angle 32.

The generally harsh environment in which the ladder deployment system 10 would be utilised requires the deployment system to be as simple as possible. Thus the track system, by the use of the peripheral flange 28 and the engagement of the rollers 34 and 36 and the use of hydraulic cylinder 44 to provide a deployment mechanism is considered to be the simplest and least in need of maintenance than other systems which might be utilised.

However, such other systems which might also be utilised include the replacement of the hydraulic cylinder 44 by a different motive power means. Such a motive power means might be the use of a cable or chain and hydraulic winch to wind the cable or chain in an upward direction so as to move the ladder side rails 14 and 16 from the lowered condition to a raised condition. When it is desired to move the ladder 12 to the lowered condition, the hydraulic motor is simply reversed with the mass of the ladder 12 and gravity providing the motive power to move the ladder 12 from the raised condition to the lowered condition.

Another alternative would be to replace the lower roller 36 with a pinion mounted to a drive shaft of a hydraulic motor and providing a rack arrangement on the internal face of one side of the peripheral flange 28 whereby the raising and lowering is performed by the hydraulic motor driving a pinion which then translates the rack and thus the side rails 14 and 16.

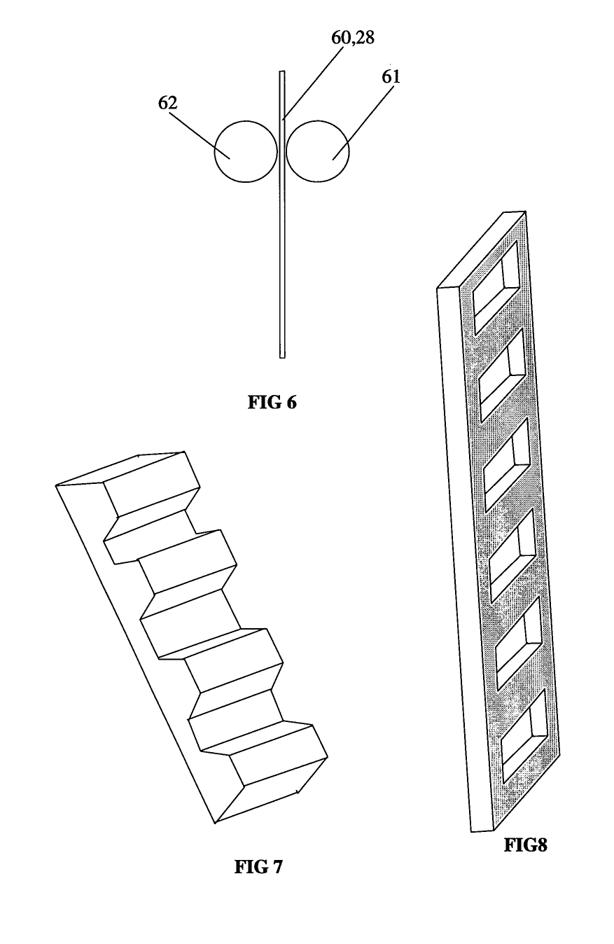

A similar result can be achieved by the use of a centrally located and extending track relative to the face 26, or the use of dual opposed rollers to engage the flange 28. In this case as illustrated in FIG. 6, a track 60 (or the flange 28) can be held between two pairs of guide rollers 61 and 62. By providing the track 60 with a rack or alternatively a series of apertures, as illustrated in FIGS. 7 and 8 respectively, which can be engaged by a toothed pinion, an alternative drive mechanism can be achieved.

If desired, the raising or lowering of the ladder 12 can be manually attended to by the operator, or if desired, when the ladder 12 is in the lowered condition, a control switch or trigger can be used to engage the lift mechanism to raise the ladder 12 once the vehicle parking brake is released.

In the description of the above embodiments, one hydraulic cylinder 44 is utilised per side rail 16 and 14. If desired a single hydraulic cylinder may be utilised, but this may require a more rigid ladder structure to prevent twisting of the ladder.

Also in the above described embodiments, the hydraulic cylinders 44 have a length which is approximately equal to the length of the piston or rod 46, so as to accommodate the length of travel required. If desired a shorter cylinder can be used, however a multi-stage telescoping piston and rod can be utilised.

The above described systems locate the hydraulic cylinders 44 at the sides of side rails 14 and 16. Another location that the or a hydraulic cylinder could be located, to raise and lower the ladder 12 is a generally central location beneath the ladder 12 and or between the rungs or steps and the vehicle body or chassis.

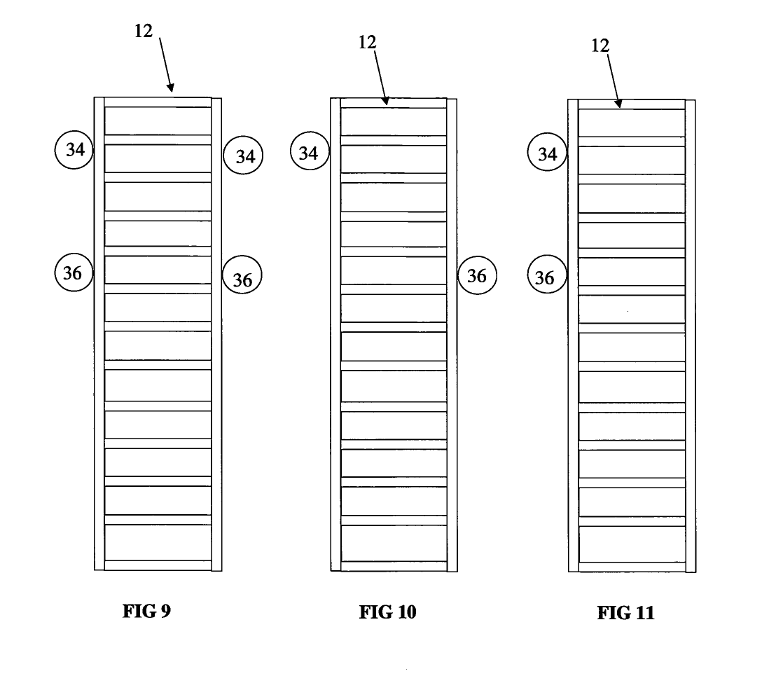

Illustrated in FIG. 9 is a schematic of the ladder 12 and its guide means 34 and 36, on either side of the ladder 12. In this arrangement a guide wheel engages the side rail tracks at an upper and lower location on either side of the ladder 12.

Whereas in FIG. 10 is a schematic of the ladder 12 having one guide means 34 on one side of the ladder 12 engaging the side rail track, and another guide means 36 on the other side of the ladder 12, engaging the respective side rail track and being spaced at a lower location than the guide means 34. This embodiment may also suffer from issues of twisting issues and additional rigidity may be required in the ladder 12's construction.

In FIG. 11 is a schematic of the ladder 12 having one guide means 34 on one side of the ladder 12 engaging the side rail track, and another guide means 36 on the same side of the ladder 12, engaging the same side rail track at a lower location. This embodiment may also suffer from issues of twisting issues and additional rigidity may be required in the construction of the ladder 12.

The above described embodiments also describe the track system on the ladder 12 being arranged on the sides or in conjunction with the side rails 14 and 16. If desired, the track and guide means can be either centrally located under the ladder 12 and its associated steps or rungs 18, or arranged under the ladder 12 with respective tracks under the side rails or built within the confines thereof.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A ladder deployment system for raising and lowering a ladder said system including a ladder having side rails and transverse supports extending between said side rails, an actuator mechanism adapted and configured to move said ladder between a raised condition and lowered condition and stationary guide means, said guide means supporting said ladder at two or more spaced apart locations at different heights, while said ladder translates relative to said guide means.

2. A ladder deployment system as claimed in claim 1, wherein said actuator mechanism directly engages said ladder.

3. A ladder deployment system as claimed in claim 1, wherein said actuator mechanism is associated with said guide means.

4. A ladder deployment system as claimed in claim 1, wherein said actuator mechanism is independent of the guide means.

5. A ladder deployment system as claimed in claim 1, wherein said actuator mechanism includes a linear actuator connected between a stationary location and said ladder to deploy said ladder.

6. A ladder deployment system as claimed in claim 1, wherein said side rails include one or more tracks to engage said guide means.

7. A ladder deployment system as claimed in claim 6, wherein said guide means is located between tracks located on said side rails.

8. A ladder deployment system as claimed in claim 6, wherein said guide means are located either side of a track located on said side rails.

9. A ladder deployment system as claimed in claim 1, wherein said track and said guide means have respectively a rack and pinion construction.

10. A ladder deployment system as claimed in claim 1, wherein said actuator mechanism drives said pin to move said track relative to said guide means.

11. A ladder deployment system as claimed in claim 1, wherein said actuator mechanism includes a winch and ligature, such as a chain or cable, which operate to lift said ladder to a raised condition with gravity being used in association with said winch to move said ladder to a lowered condition.

12. A ladder deployment system as claimed in claim 1, wherein said ladder side rails have at least two straight sections, said straight sections being at an angle to each other.

13. A ladder deployment system as claimed in claim 1, wherein said at least two straight sections both engage said guide means.

14. A ladder deployment system as claimed in claim 1, wherein said system has one ladder section in a generally vertical orientation when said ladder is in the lowered condition.

15. A ladder deployment system as claimed in claim 1, wherein said system has a second ladder section in a generally vertical orientation when said ladder is in the raised condition.

16. A ladder deployment system as claimed in claim 1, wherein movement of said ladder relative to said guide means results in said ladder rotating at a location in said movement as the ladder is deployed between the raised condition and the lowered condition.

17. A ladder deployment system as claimed in claim 1 wherein said guide means is attached to a vehicle.

18. A ladder deployment system as claimed in claim 17 wherein said actuator mechanism is attached to a vehicle.

19. A ladder deployment system as claimed in claim 1, wherein said actuator mechanism is secured to a housing or mounting for said guide means.

20. A ladder deployment system as claimed in claim 1 wherein said ladder includes a hand rail which translates and rotates with said ladder.

21. A ladder deployment system as claimed in claim 20, wherein said ladder deployment system is adapted for mounting to a vehicle, wherein, in said lowered condition the ladder and hand rail are located at respective first positions outwards of said vehicle, and wherein in movement between the lowered and the raised conditions, said ladder and said hand rail do not travel more inwards relative to said vehicle than said respective first positions.

22. A ladder deployment system as claimed in claim 1 wherein said system is controlled to raise said ladder to said raised condition, in response to a vehicle's parking brake being released.

23. A ladder deployment system as claimed in claim 1, wherein said two or more generally vertically spaced apart locations are paired on either side of said ladder.

24. A ladder deployment system as claimed in claim 1, wherein said guide means comprises a first guide assembly located on one side of said ladder at a first height and a second guide assembly located on an opposite side of said ladder at a second height which is different to said first height.

25. A ladder deployment system as claimed in claim 1, wherein said two or more generally vertically spaced apart locations, are located one a single side of said ladder.

26. A ladder deployment system as claimed in claim 1, wherein the actuator mechanism and the ladder in combination is adapted to impart to the ladder in sequence a first translation motion to said ladder, as the ladder moves relative to the guide means, a rotation motion, and a further translation motion.

27. A ladder deployment system as claimed in claim 26, wherein the actuator mechanism provides the translation, then rotation then translation motion when the ladder is being raised and lowered.

28. A ladder deployment system for raising and lowering a ladder between a raised position and a lowered, inclined position, the system including a ladder having side rails and transverse supports extending between the side rails, and deployment actuator means and guide means adapted to deploy the ladder in one stage comprising generally vertical translation of the ladder and another stage including tilting the ladder between generally vertical and inclined dispositions.

29. A ladder deployment system as claimed in claim 28, wherein said guide means engages the ladder at two or more points at different heights.

30. A ladder deployment system as claimed in claim 29, wherein said different heights are at generally vertically spaced apart positions.

31. A ladder deployment system as claimed in claim 28, wherein said guide means constrains the inclination of a portion of the ladder which is engaged with the guide means at the time.

32. A ladder deployment system as claimed in claim 28, wherein the ladder includes upper and lower ladder portions disposed at an angle relative to each other, and engagement of the ladder with said guide means in a transition portion between the upper and lower ladder portions results in the tilting stage of the deployment.
